(19) United States
(12) Patent Application Publication
(10) Pub. No.: US 2026/0233985 A1
(43) Pub. Date: Aug. 13, 2026

(54) ENERGIZABLE EXPANDABLE CAPACITY BELT APPARATUS AND METHOD FOR EXTRACTING LIQUID FROM INDUSTRIAL PRODUCT CONTAINERS

(71) Applicant: J. Nicholas and Kristin Gross Trust U/A/D April 13, 2010, Berkeley, CA (US)

(72) Inventor: John N Gross, Berkeley, CA (US)

(21) Appl. No.: 19/350,031

(22) Filed: Oct. 5, 2025

Related U.S. Application Data
(60) Provisional application No. 63/703,390, filed on Oct. 4, 2024.

(51) Int. Cl. B67D 7/02

(52) U.S. Cl. CPC B67D 7/02

(57) ABSTRACT

An apparatus adapted to remove industrial type liquids from large vats, barrels, cans and containers is disclosed, with active energy delivery elements designed to dislodge and cause movement of the material from interior sidewalls within the container using vibrational energy to overcome viscosity. The apparatus includes an energizable wrap structure with vibration elements to deliver vibrational energy to a container in an efficient manner and shake loose hard to remove material collected in the container. Additional heating elements can be employed to reduce viscosity and improve flow as well. During an activation mode electrical energy can be used to power the vibration elements such that controlled and continuous removal of material can be achieved.

### RELATED APPLICATION DATA

The present application claims the benefit under 35 U.S.C. 119(e) of the priority date of Provisional Application Ser. Nos. 63/703,390 filed Oct. 4 2024 which is hereby incorporated by reference.

### FIELD OF THE INVENTION

The present invention generally relates to the field(s) of fluid extraction technology from containers. More specifically, embodiments of the present invention pertain to an expandable capacity energizable belt apparatus and method for helping remove high viscosity materials from large industrial tanks using vibrational and/or heat energy.

### BACKGROUND OF THE INVENTION

Liquid industrial products, such as paints, oils, etc. are distributed in multiple container forms 170 as seen in FIG. 5A, which depicts a number of shapes and sizes for contemporary materials, including crude oil (transported in truck/train tankers, vats, and barrels) and paint. Oil and other products are frequently dispensed using pumps and nozzles as seen in FIG. 5A. It will be understood that other liquids/containers, including some food products (including oils) are available in commerce and that this is merely a cross section of some common forms.

A common problem that arises with highly viscous industrial liquids is depicted in FIG. 5B. In particular, as material 180 in a container or vat 170 is drained using a drain 171 or pump 176 through an access hole 174, a significant amount of material can accumulate and remain on sidewalls 172. It is estimated that 3-5% of the 8400 gallons heavy duty liquids such as oil can remain in a tank 170, resulting in a loss of more than 250 gallons of material. For certain types of materials, or even larger containers, this kind of waste or loss can be extremely expensive, especially when multiplied over hundreds of transport events daily.

Consequently, there is a long felt need for improved devices and methods for extracting liquid from large vats and containers beyond the solutions offered to date, to reduce waste and loss. This “Discussion of the Background” section is provided for background information only. The statements in this “Discussion of the Background” are not an admission that any particular subject matter disclosed in this “Discussion of the Background” section constitutes prior art to the present disclosure, and except for those portions specifically identified as prior art no part of this “Discussion of the Background” section may be used as an admission that any part of this application, including this “Discussion of the Background” section, constitutes prior art to the present disclosure.

### SUMMARY OF THE INVENTION

An aspect of the present disclosure therefore is to provide systems and methods which address the limitations in the prior art noted above.

A first aspect of the disclosure pertains to an apparatus (and associated method) that facilitates movement and flow of a liquid material in a container to make it more easily and quickly dispensable compared to prior art techniques.

A second aspect of the disclosure pertains to an apparatus (and associated method) that increases an absolute amount of starting liquid material dispensed from a container.

A third aspect of the disclosure relates to employing vibrational energy, heat energy, or a combination thereof, to reduce viscosity of a liquid and/or increase flow within a container to increase ease/control of material removal.

These and other aspects of the inventive embodiments are described in detail below. It will be understood and appreciated by skilled artisans that not all embodiments of the invention need incorporate all aspects as described above, and that the scope of the invention(s) herein is/are defined exclusively with reference to the claims set out below.

### DESCRIPTION OF THE DRAWINGS

FIG. 1 shows a first embodiment of an expandable capacity energized liquid extraction apparatus which includes an energizable wrap or belt with energizable vibrating elements to secure and facilitate removal of material from a container positioned and secured within;

FIG. 2 shows a first example of an application of the liquid extraction apparatus as it would be employed to remove a liquid material from a conventional bucket container holding a viscous fluid;

FIG. 3 shows a second example of an application of the liquid extraction apparatus as it would be employed to remove a liquid material from a conventional storage tank holding a viscous fluid;

FIGS. 4A and 4B show an embodiment of an electrical control circuit and control panel respectively used in implementations of the described apparatuses;

FIG. 5A depicts examples of prior art storage containers, including tanks, vats, barrels and cans for storing industrial products;

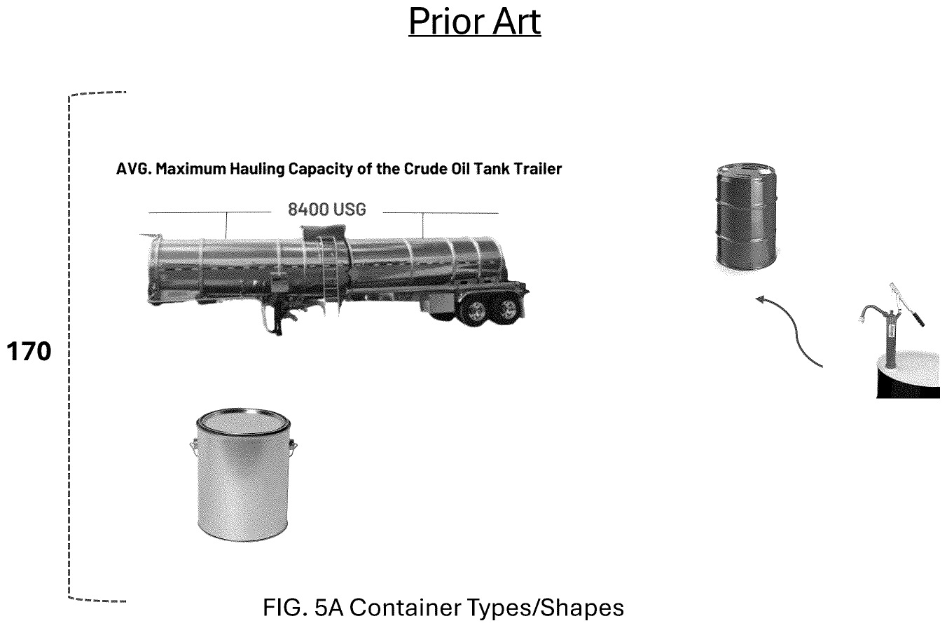

FIG. 5B visually depicts settling of a typical highly viscous material on sidewalls of a container as occurs naturally over time.

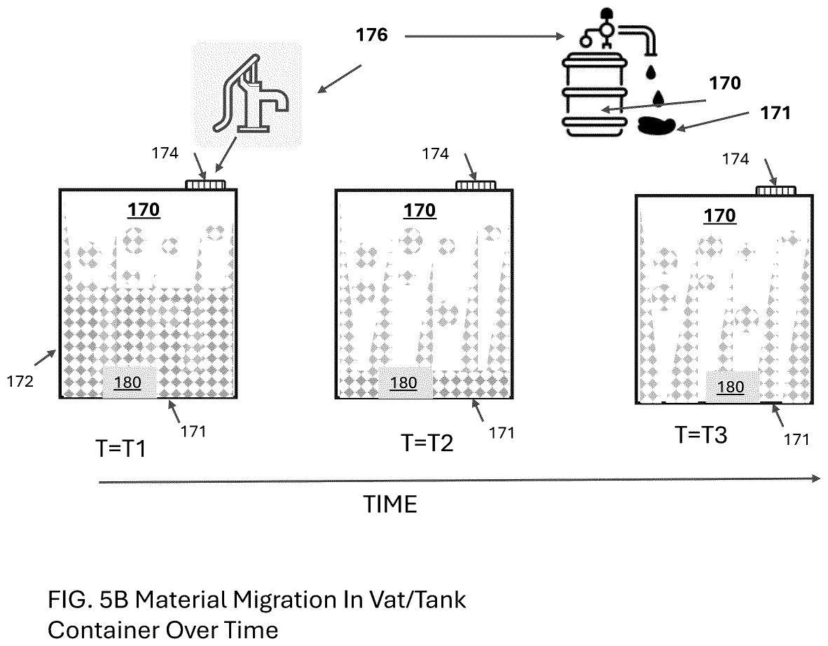

### DETAILED DESCRIPTION

Reference will now be made in detail to various embodiments of the invention, examples of which are illustrated in the accompanying drawings. While the invention will be described in conjunction with the following preferred embodiments, it will be understood that the descriptions are not intended to limit the invention to these embodiments. On the contrary, the invention is intended to cover alternatives, modifications and equivalents reasonably understood by persons of ordinary skill in the art to be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, it will be understood by those skilled in the art that variations that are not inconsistent may be mixed and matched as desired.

As discussed above, containers such as vats, storage tanks, cans, barrels, etc. are used for storing any number of liquid industrial products having different viscosities. The viscosity of a fluid is a measure of its resistance to deformation or flow at a given rate. The magnitude of the viscosity of a fluid directly affects how easily it flows out of a container. This is why it easier to pour water (low viscosity) out of a bottle than ketchup (high viscosity). To make a fluid flow out of a container therefore, one can either change/reduce the viscosity of the material to make it more easily flowable, and/or apply sufficient force to overcome the deformation resistance.

Embodiments of the present invention as discussed herein use other controllable applied energy and forces—preferably in the form of vibrational energy powered from an electrical source—to overcome the liquid viscosity beyond just passive gravity and manual shaking. Vibrational energy is provided to one or more surfaces of the container (top, bottom, sides, etc.), which has the effect of both heating the material to reduce viscosity, and through such added force combined with gravitational force, is sufficient to overcome any flow resistance and cause the material to flow to the bottom of the container for easier dispensing. The amplitude and frequency of vibrational energy can be controlled easily using conventional techniques to allow for a wide range of extractions of different types of materials from any type of container.

Viscosity is affected by other influences and factors as well, including temperature. Higher temperature decreases the viscosity of fluids due to the increased kinetic energy of the molecules. Raising the temperature of some liquids too much however is undesirable as it will compromise their composition, taste, etc. Accordingly, any heating of a container to reduce viscosity preferably should be done in the smallest area for the shortest period of time, and at a temperature that is below that which could impair the texture, taste, longevity, etc. of the material in question.

In selected embodiments of the present invention heat energy therefore is also exploited to reduce viscosity selectively in areas (e.g. typically proximate to a sidewall surface) of a container. This has the effect of causing flow of the material at the interface to the sidewall, bringing about an avalanche effect with the rest of the material. This additional heat energy is preferably applied in a controllable area, for a predefined time and at a predetermined temperature that is tailored to the container, material, etc.

Furthermore viscosity is also affected by changes in the composition of the material as a result of environmental factors. Some liquids may separate out and cause a portion of the mass to dry out and become more viscous; this is noticeable when a container is turned upside down and the first material to flow is water. The most common technique to fix this again is to shake the container to homogenize the ingredients. Embodiments of the present invention can effectuate the same kind of viscosity reduction and increased homogenization through vibrational energy.

All reference numbers used herein correspond to the same structure in each figure unless otherwise indicated.

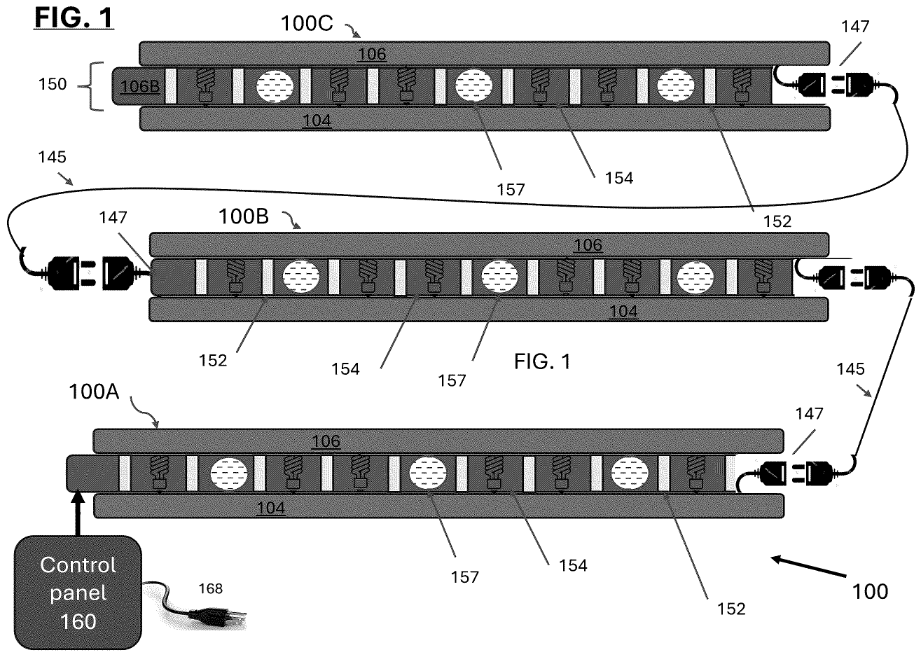

FIG. 1 shows a first embodiment of an expandable capacity energized liquid extraction apparatus which includes an energizable multisegment wrap or belt 100 with energizable vibrating elements to secure and facilitate removal of material from a container positioned and secured within. An energizable wrap 100 has expandable capacity in that it can be formed as a composite of multiple individual wraps 100A, 100B, 100C (which have differing sizes and capabilities), electrically coupled together to form a structure that can be sized and can used for a specific sized container. Each wrap (e.g. 100A, 100B, 100C) preferably has both a positive and a negative receptacle 147 for accommodating an electrical plug 145 to permit them to be daisy-chained together.

Each wrap 100 includes a body portion 104/106, embedded vibrational elements 152, optional heating elements 154, and reverberation elements 157. The body portion 104/106 can be made of any suitable cloth material, including cotton, denim, synthetics, etc., and preferably has some elasticity that allows for it to stretch, allowing it to conform and surround a container shape.

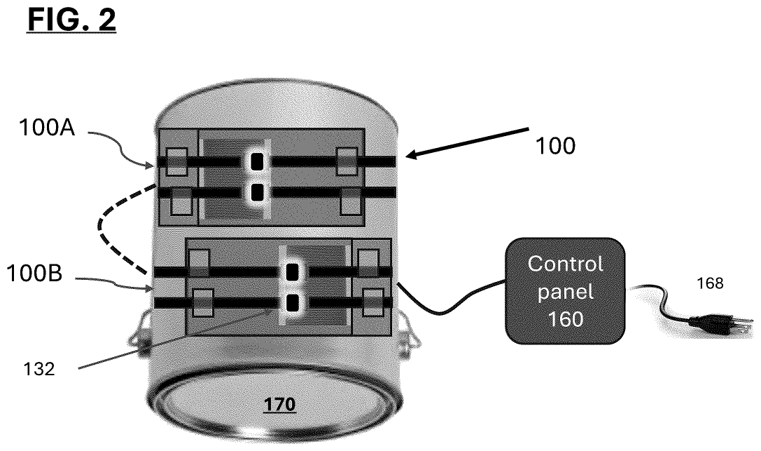

The flexible activatable wrap 100 is a sandwich structure which includes two exterior facing layers 104/106 and a flexible interlayer 150. The wrap is shaped, sized and arranged to allow folding of the wrap 101 to secure, envelope and surround a container 170 with activatable energy delivery elements as noted below. It will be understood from the present description that the number, arrangement and interaction of the wrap components can be implemented through several similar satisfactory arrangements. The wrap 100 further includes fastening elements 132 (FIG. 2), which can clips/hooks, or any other structure known in the art that are compatible with the objectives of the present teachings. These contact fastening elements, as described below, operate to secure a container 170 with the wrap 100, and maintain contact by the energy delivery elements to the container.

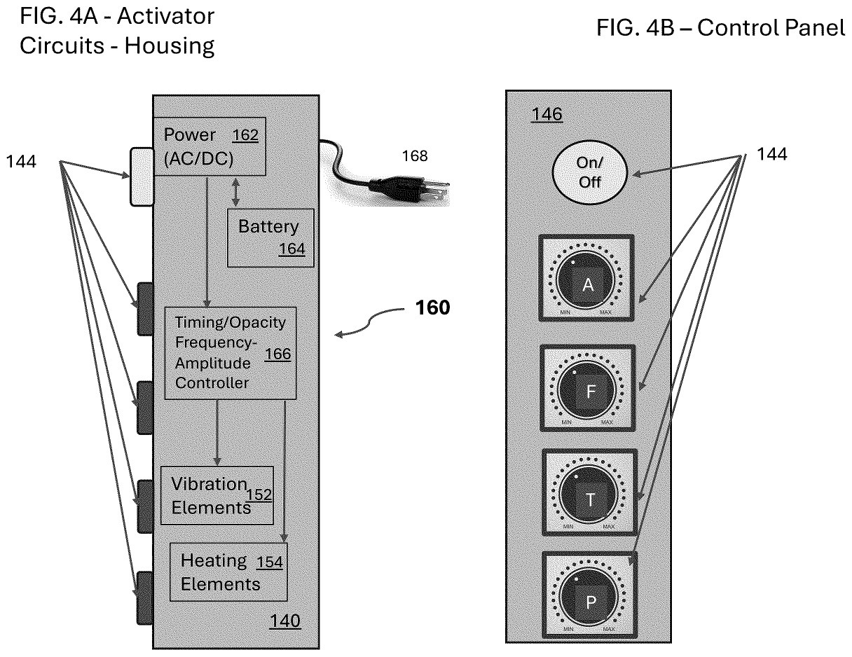

A control panel 160 (see FIGS. 4A, 4B) is used to control an operation of the energizable wrap 100, including parameters such as amplitude, frequency, heat intensity, timing, etc. The wrap 100 is preferably powered through an AC source which may be 110V, 220V, etc. and can also be based on portable power generating units. As noted above, the capacity of the energy of the wrap 100 can be increased and sized as needed by adding additional wraps 100A, 100B, and so forth.

When energized, the active elements in wrap 100 (vibrating elements 152 and heating elements 154) are electrically powered to deliver vibrational and heat energy to a container surface. The size, shape and number of vibration elements 152 and heating elements 154 can be varied as needed to accommodate a particular container and liquid therein and power availability for the material dislodging operation.

FIG. 2 shows a first example of an application of the liquid extraction apparatus 100 as it would be employed to remove a liquid material (such as paint, oil, etc.) from a conventional bucket sized container 170 holding a viscous fluid. The wrap 100 here consists of two electrically coupled wraps 100A, 100B fastened together by conventional clip or cinch type fastening elements 132. These types of cinch fastening elements preferably are in the form of spring fit clips and when slack tightened operate to increase a contact pressure of the vibrating and heating elements in the wrap on a surface of container 170. Again material in container 170 is thus dislodged and flowed through a combination of vibrational and heat energy.

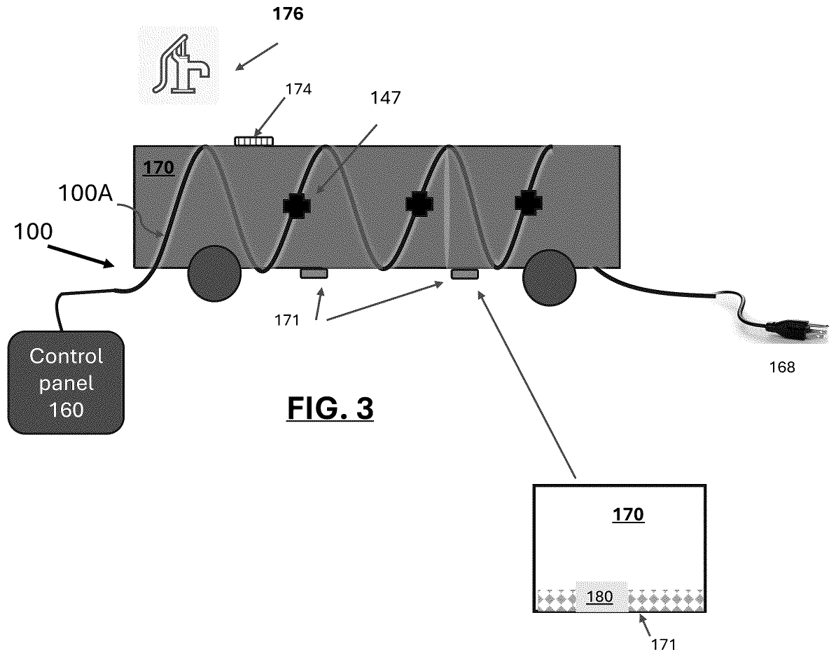

FIG. 3 shows a second example of an application of the expandable capacity liquid extraction apparatus 100 as it would be employed to remove a liquid material from a larger conventional storage tank holding a viscous fluid. In such instances a container 170 may be emptied through a bottom drain 171, and/or by a pump 176 accessing a top lid 174. The energized composite wrap 100 consists of multiple chained wraps 100A arranged across and around a container body 170 to deliver maximum vibrational and optional heat energy over a large portion of a surface area.

Persons skilled in the art will appreciate that a large assortment of known vibrating elements 152 and heating elements 154 can be employed in embodiments of the present disclosure. As seen in FIG. 4A, to supply the power for the energy delivery elements 152/154, an AC source 162 can be used depending on the desired container form factor and energy requirements for the materials in question. In some applications, however, battery power 164 (in the form of standard batteries or rechargeable batteries) is sufficient to provide useful results for the bulk of liquids and containers. Note that the vibrational energy need only be sufficient to cause movement of the material, and accordingly is not likely to cause damage to the container.

The energy/frequency settings can be used to generate sufficient and optimal energy to the container to induce flow of liquid therein. The particular amplitude, frequency, time, etc., can be adjusted and set as well through control knobs/dials 144 using a control circuit 160 to accommodate different sized containers and different types of liquids. For example, the settings for removing oil from a large, thick tanking container may be significantly different than those used for removing paint from a thin bucket or can. By enabling different controllable settings, material can be extracted from a wide number of industrial products items.

FIGS. 4A and 4B show an embodiment of a housing and control circuit that can be utilized in the present embodiments. The panel 146 of FIG. 4B depicts controls in the form of switches, dials, knobs, etc. 144 that are presented on the spine 140. In preferred embodiments the user can alter a number of parameters of the vibration apparatus, including an amplitude (A) of the vibrations, a frequency/mode (F) of the vibrations, a time (T) for the vibrating operation, and a heat intensity (H) used by the heating elements. It will be understood that the placement of the controls, the types of controls, and their specific implementation form can be varied in accordance with any desired form factor. For example some controls may be omitted for simplicity and cost reasons, and they may be placed in different parts of the apparatus for convenience (e.g. an on/off switch).

FIG. 4A identifies the basic components of the activator circuit that controls the vibration and heating of containers. This includes a power source (AC/DC) 162 which could be sourced from conventional AC power 168, discrete battery power 164 (e.g. batteries) and/or rechargeable batteries. Energy is provided to the container directly through vibration elements 152 and optionally heating elements 154, which may be included in the base, sleeve, cap, and/or strap structures as discussed above. Electrical connections for supplying control and/or power to these elements can be routed through these structural components as well.

The end result of a vibration process is that the material 180 is dislodged and collects in the bottom of the container 170 where it can be more conveniently removed or retrieved through drain 171 as seen in FIG. 3. In some instances the containers are already adapted to use pressure to expel the contents, and therefore the invention facilitates this process by concentrating the material in the most useful region of the container. That is, the apparatus 100 of the present invention can bring about a more rapid and complete distribution of the material to the end of the container where it can be efficiently removed using one of these prior art devices.

Note that the embodiment disclosed herein is superior to the prior art techniques. The benefits of using high powered active vibrational energy include faster, more effective movement of the fluid into a region of the container where it can be more easily and efficiently removed on a comparative volume basis. In other words, embodiments of the invention allow for a recovery of a greater amount of existing volume of material present in the container.

It will be understood by those skilled in the art that the above descriptions are merely examples and that countless variations of the invention can be implemented in accordance with the present teachings. A number of other conventional structures that would be included in a commercial product have been omitted, as well, to better emphasize the present teachings. It is understood that the protection afforded the present invention also comprehends and extends to embodiments different from those above, but which fall within the scope of the claims presented below.

What is claimed is:

1. An expandable capacity apparatus for assisting movement of a volume of fluid situated on interior sidewalls of a solid container, which container has a first top portion and a second bottom portion comprising:
a. a flexible energy delivery wrap including:
i. a first body portion adapted to hold one or more vibration elements, which vibration elements are activatable by electric energy;
wherein at least a first body surface of said body portion is adapted to make contact with the solid container and position said vibration elements in proximity to a first container surface;
ii. a first end portion including a receptacle and/or plug for electrically connecting the flexible energy delivery wrap to another separate second energy delivery wrap;
iii. one or more fastening elements attached to either or both said first body portion and said end portion, said one more fastening elements being adapted to assist in maintaining said wrap in close contact with said solid container;
iv. an electrical control circuit coupled to the vibration elements and adapted to provide a power source sufficient to activate said vibration elements;
wherein the apparatus includes an activation mode enabled by electrical power, during which activation mode the apparatus can apply sufficient vibrational energy to the container through at least the first container surface to assist and facilitate movement of the volume of fluid on the interior sidewalls in a direction extending from the first top portion of the container to a bottom end portion of the container.

2. The apparatus of claim 1 further including heating elements incorporated within said first body section adapted to heat a surface of the solid container.

3. The apparatus of claim 1 wherein said electrical control circuit is adapted to control at least one of an amplitude and frequency of vibrations generated by said one or more vibration elements.

4. The apparatus of claim 1 wherein the volume of fluid can be removed in a first time from the container using said activation mode that is substantially shorter than a second time required for a gravity or passive treatment of the container.

5. The apparatus of claim 1 wherein the volume of fluid can be removed continuously and smoothly from the container during said activation mode.

6. The apparatus of claim 1 wherein capacity for the apparatus can be expanded by connecting the flexible energy delivery wrap to the separate energy delivery wrap to form a longer composite energy delivery wrap connected together in a daisy chain manner.

7. The apparatus of claim 1 further including solid reverberation elements incorporated within the energy delivery wrap to enhanced the delivery of vibrational energy to the container.
